(19) United States
(12) Patent Application Publication
(10) Pub. No.: US 2017/0364727 A1
(43) Pub. Date: Dec. 21, 2017

(54) DISPLAY DEVICE

(71) Applicant: BOE TECHNOLOGY GROUP CO., LTD., Beijing (CN)

(72) Inventor: Tian YANG, Beijing (CN)

(73) Assignee: BOE Technology Group Co., Ltd.

(21) Appl. No.: 15/540,183

(22) PCT Filed: Sep. 29, 2016
(86) PCT No.: PCT/CN2016/100806

§ 371 Date: Jun. 27, 2017

(30) Foreign Application Priority Data
Oct. 9, 2015 (CN) 201510648557.0

(51) Int. Cl. G06K 9/00; G06F 21/32; G06F 3/041

(52) U.S. Cl. CPC G06K 9/0002; G06K 9/00087; G06F 3/0412; G06F 21/32; G06K 9/00053

(57) ABSTRACT

A display device, including a display panel and a transparent cover plate disposed on the display panel, a first side of the transparent cover plate close to the display panel is provided with a full-screen fingerprint sensor and a fingerprint identification alarm circuit. The full-screen fingerprint sensor is configured to acquire fingerprint information at a surface of a second side of the transparent cover plate opposite to the first side, including a receiving unit, an extracting unit, a comparison unit and an alarming unit which are connected successively.

### TECHNICAL FIELD

Embodiments of the present invention relate to a display device.

### BACKGROUND

With development of intelligent terminal devices, much information concerning personal privacy, especially personal finance business information, involves risk of revealing. For example, in known technology, a mobile phone is usually correlated with a credit card as one of identity authentication modes. As a result, in case of missing the mobile phone, important information of the owner of the mobile phone may be revealed, leading to unauthorized charges of the credit card and hence huge loss. Thus, existing electric devices have to be managed with high-level safety which allows for intelligent user identification. In this regard, although partial fingerprint identification has been realized by integrating of fingerprint identification technology, the user experience is poor due to complex identification steps. Therefore, it has become one of the urgent issues in the related art that how to identify a user without affecting normal operation of the user.

### SUMMARY

In view of the above defects, at least one embodiment of the present invention provides a display device which achieves automatic identity authentication while ensuring the normal operation of the user.

In order to achieve the objectives above, embodiments of the present invention provide technical solutions as below.

A display device, including a display panel; and a transparent cover plate disposed on the display panel, wherein a first side of the transparent cover plate close to the display panel is provided with a full-screen fingerprint sensor and a fingerprint identification alarm circuit, wherein the full-screen fingerprint sensor is configured to acquire fingerprint information at a surface of a second side of the transparent cover plate opposite to the first side. The fingerprint identification alarm circuit includes: a receiving unit connected to the full-screen fingerprint sensor and configured to receive the fingerprint information from the full-screen fingerprint sensor; an extracting unit connected to the receiving unit and configured to extract a fingerprint feature from the fingerprint information received by the receiving unit; a comparison unit connected to the extracting unit and configured to compare the fingerprint feature extracted by the extracting unit with a pre-stored fingerprint feature; and an alarm unit connected to the comparison unit and configured to perform an alarm operation upon the fingerprint feature being inconsistent with the pre-stored fingerprint feature.

In an example, the transparent cover plate is formed with a plurality of blind holes extending along a thickness direction of the transparent cover plate; a depth of the blind hole is smaller than a thickness of the transparent cover plate; and the blind hole is filled with a dielectric anisotropy material.

In an example, the dielectric anisotropy material has an optical property similar to that of the transparent cover plate.

In an example, the blind hole has a first end reaching to the surface of the first side of the transparent cover plate; and the first end of each of several blind holes is connected with a first conducting plate.

In an example, the blind hole has a second end reaching to a surface of the second side of the transparent cover plate; and the second end of each of several blind holes is connected with a second conducting plate.

In an example, the full-screen fingerprint sensor is attached onto the surface of the first side of the transparent cover plate by a bonding layer.

In an example, the display further includes a transparent dielectric layer disposed between the display panel and the transparent cover plate.

In an example, the transparent dielectric layer is selected from a group consisted of color filter; polarizer and liquid optically clear adhesive (LOCA).

In an example, the fingerprint identification alarm circuit is disposed on a flexible circuit board; the flexible circuit board is disposed on a side of the full-screen fingerprint sensor far away from the transparent cover plate and is electrically connected with the full-screen fingerprint sensor.

In an example, the fingerprint identification alarm circuit is disposed in a peripheral circuit region of the display panel and is connected with the full-screen fingerprint sensor through a lead.

In an example, the fingerprint identification alarm circuit further includes a memory unit connected with the comparison unit; the memory unit is configured to store the pre-stored fingerprint feature.

In an example, the fingerprint identification alarm circuit further includes an energy-storage power supply.

In an example, the full-screen fingerprint sensor is further configured to acquire touch information on a surface of the second side of the transparent cover plate.

In an example, the transparent cover plate is selected from a group consisted of flat plate, curved plate, cylinder and sphere.

In an example, the transparent cover plate is configured to enclose the display panel in a cavity formed by the surface of the first side of the transparent cover plate; and a surface of the second side of the transparent cover plate is formed as an outer surface of the display device.

### BRIEF DESCRIPTION OF THE DRAWINGS

Hereafter, the embodiments of the present invention will be described in a more detailed way with reference to the accompanying drawings, so as make one person skilled in the art be able to understand the present invention more clearly, wherein:

FIG. 1 is a schematic view illustrating an entire structure of a display device provided by an embodiment of the present invention;

FIG. 2 is a schematic view illustrating a partial structure of the display device illustrated in FIG. 1;

FIG. 3 is a schematic structural view of a display device provided by another embodiment of the present invention;

FIG. 4 is a schematic structural view of a display device provided by yet another embodiment of the present invention;

FIG. 5 is a schematic structural view of a display device provided by still another embodiment of the present invention.

### DETAILED DESCRIPTION

Hereafter; the technical solutions in the embodiments of the present disclosure will be described in a clearly and fully understandable way in connection with the drawings in the embodiments of the present disclosure. It is obvious that the described embodiments are just a part but not all of the embodiments of the disclosure. Based on the described embodiments herein, one person skilled in the art can obtain other embodiment(s), without any inventive work, which should be within the scope of the disclosure.

Unless otherwise defined, the technical terminology or scientific terminology used herein should have the same meaning as commonly understood by one of ordinary skill in the art to which this invention belongs. Likewise, terms like “first,” “second,” etc., which are used in the description and the claims of the present application for invention, are not intended to indicate any sequence, amount or importance, but distinguish various components. The phrases “connect”, “connected”, etc., are not intended to define a physical connection or mechanical connection, but may include an electrical connection, directly or indirectly. “On,” “under” “left,” “right” or the like is only used to describe a relative positional relationship, and when the absolute position of a described object is changed, the relative positional relationship might also be changed accordingly.

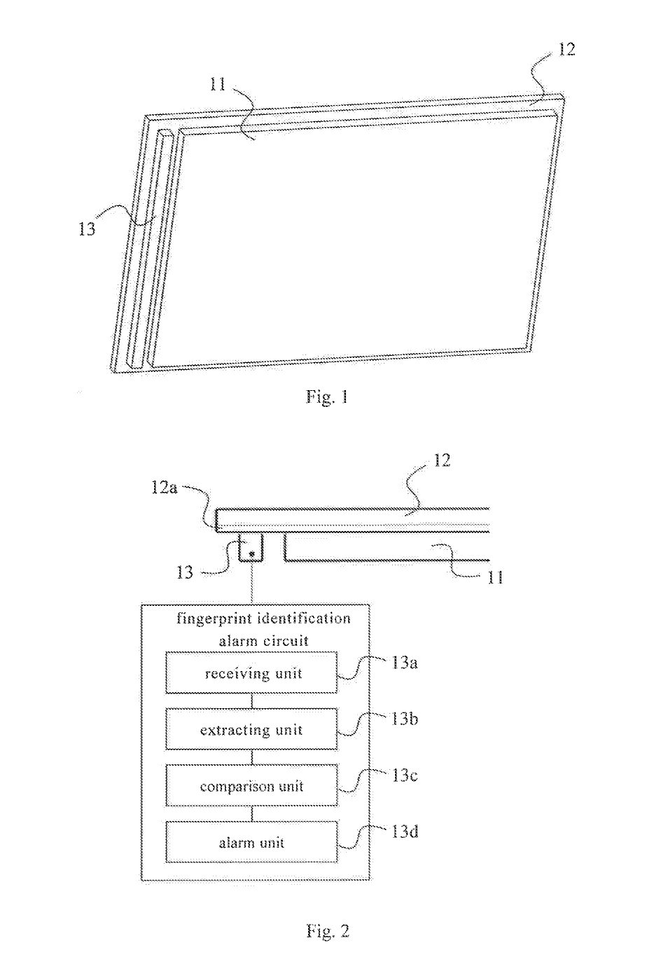

FIGS. 1-2 are schematic views illustrating a whole structure and a partial structure of a display device provided by an embodiment of the present invention, respectively. Referring to FIGS. 1-2, the display device includes a display panel 11 and a transparent cover plate 12 disposed on the display panel 11. A first side of the transparent cover plate 12 close to the display panel 11 is provided with a full-screen fingerprint sensor 12a and a fingerprint identification alarm circuit 13.

In an example, the full-screen fingerprint sensor 12a is configured to acquire fingerprint information at a surface of a second side of the transparent cover plate 12 opposite to the first side. It should be understood that, the full-screen fingerprint sensor 12a may be a capacitance or inductive electromagnetic sensor, a piezoelectric sensor, an ultrasonic sensor, an optical sensor and the like, without particularly limited in the embodiments of the present invention. Furthermore, the full-screen fingerprint sensor 12a may cover the whole surface of the first side of the transparent cover plate 12 to achieve the function of acquiring the fingerprint information at the surface of the second side of the transparent cover plate 12, depending on the type of the sensor as adopted. Of course, in order not to affect the display function of the display panel, the full-screen fingerprint sensor 12a in the transparent cover plate 12 may be formed as transparent at least in portions corresponding to display regions of the display panel.

In an example, the fingerprint identification alarm circuit 13 may include a receiving unit 13a connected to the full-screen fingerprint sensor 12a and configured to receive the fingerprint information from the full-screen fingerprint sensor 12a; an extracting unit 13b connected to the receiving unit 13a and configured to extract a fingerprint feature from the fingerprint information received by the receiving unit 13a; a comparison unit 13c connected to the extracting unit 13b and configured to compare the fingerprint feature extracted by the extracting unit 13b with a pre-stored fingerprint feature; and an alarm unit 13d connected to the comparison unit 13c and configured to perform an alarm operation upon the fingerprint feature obtained by the extracting unit 13b being inconsistent with the pre-stored fingerprint feature.

In an example, the fingerprint identification alarm circuit 13 may further include a processor and a memory so as to perform functions of the above-mentioned units through programs stored in the memory; alternatively, the fingerprint identification alarm circuit 13 may further include digital circuits and/or analog circuits known in the art, other than processor, to implement the functions of the above-mentioned units, without particularly limited in the embodiments of the present invention. For instance, the extracting unit 13b may be implemented by a processor and image processing programs stored in a memory, in which the image processing program may be implemented by image processing portion of fingerprint identification technology known in the art without repeating herein. Of course, the alarm operation performed by the alarm unit 13d may be, for example, activating a buzzer, starting a vibrator, turning on an alarm lamp and the like. The function and structure of the alarm unit 13d may be varied depending on the form of the alarm operation as performed, without repeating herein.

As above, in the display device provided by the embodiment of the present invention, acquisition of the fingerprint information at full screen is achieved through the full-screen fingerprint sensor 12a disposed on the transparent cover plate 12, so that the fingerprint identification alarm circuit 13 may analyze the fingerprint information as acquired and perform alarm operation upon detecting an illegal user. It should be understood that, in the embodiment of the present invention, the fingerprint identification alarm circuit 13 may operate independent from the software architecture of the entire device so that the identity authorization of the user may be completed during a touch operation of the user as compared with existing technology, which ensures the privacy of the user, the safety of user property and also the safety of user information.

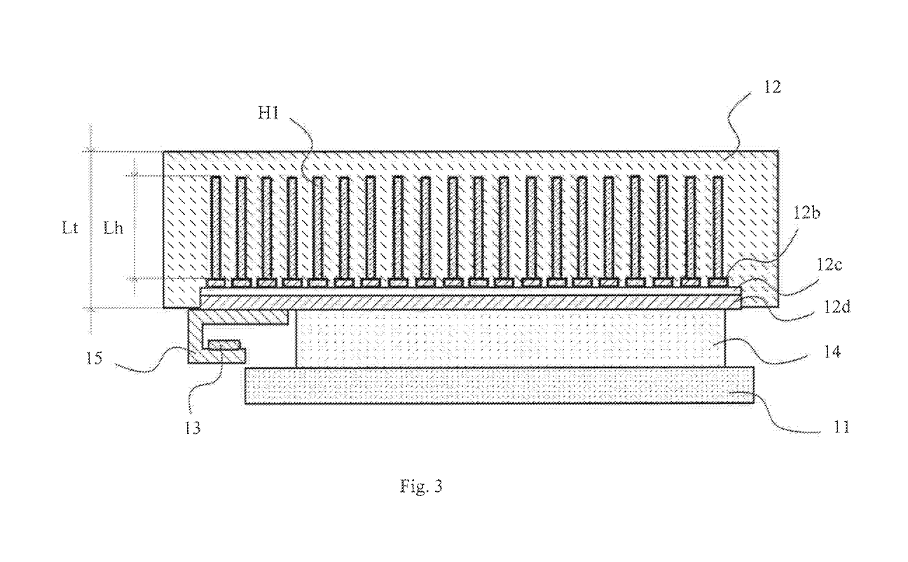

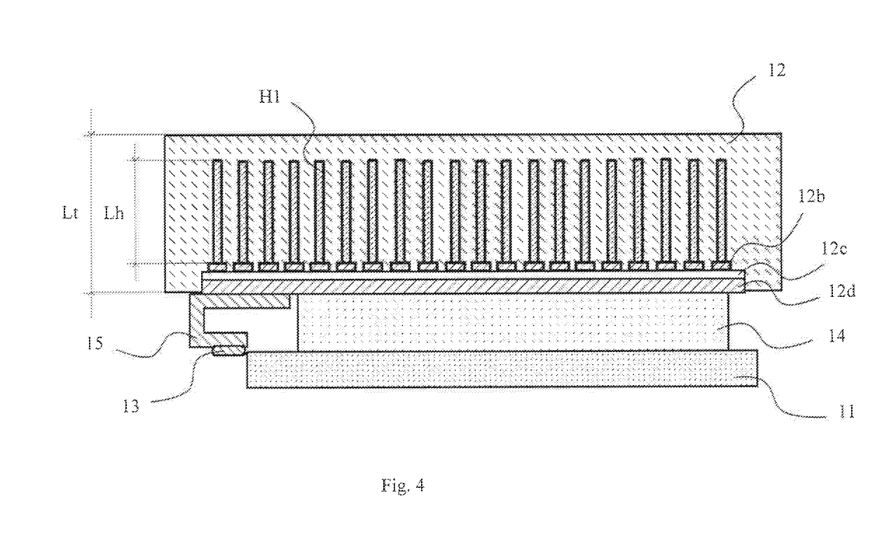

FIG. 3 is a schematic structural view of a display device provided by another embodiment of the present invention. Referring to FIG. 3, in the present embodiment, the transparent cover plate 12 is formed with a plurality of blind holes H1 extending along a thickness direction of the transparent cover plate 12; a depth Lh of the blind hole H1 is smaller than a thickness Lt of the transparent cover plate 12; and the blind hole H1 is filled with a dielectric anisotropy material. The dielectric anisotropy material is capable of changing a shape of electric field in the transparent cover plate 12 during fingerprint sensing, so as to increase the sensing effect of the full-screen fingerprint sensor 12a.

It should be understood that, the depth Lh of the blind hole H1 may be determined according to several factors such as the type of the full-screen fingerprint sensor 12a and the type of the display device. Further, the material filled in the blind hole H1 may have an optical property (e.g., color, color, transmittance, reflectivity and the like) similar to that of the transparent cover plate 12, so as to weaken a visual effect of appearance of the blind hole H1.

In an example as illustrated in FIG. 3, the blind hole H1 has a first end reaching to the surface of the first side of the transparent cover plate 12; and the first end of each of several blind holes H1 is connected with a first conducting plate 12b.

In an example as illustrated in FIG. 3, the full-screen fingerprint sensor 12a may be attached onto the surface of the first side of the transparent cover plate 12 by a bonding layer 12c. In this way, a conductive interface may be formed between the first end of the blind hole H1 and the full-screen fingerprint sensor 12a, so as to increase the sensitivity of the full-screen fingerprint sensor 12a.

It should be understood that, in the embodiment in which the full-screen fingerprint sensor 12a is a capacitance fingerprint sensor, the surface of the second side of the transparent cover plate 12 may be served as an input area of the capacitance fingerprint sensor. In this way, when the surface of the second side of the transparent cover plate 12 is touched by a finger, an electrostatic capacity of one or more units in the full-screen fingerprint sensor 12a would be changed, so that a fingerprint image can be generated based on variation of electrostatic capacity at different positions as detected. During such process, the material filled in the blind hole H1 may serve to transmit the electric signal with minimum decrement passing through the transparent cover plate 12.

It should be understood that, based on the same operation flow, the blind holes extending along the thickness direction of the transparent cover plate may have their second ends reaching to the surface of the second side of the transparent cover plate; at this point, the first ends of the blind holes may be spaced from the surface of the second side of the transparent cover plate by a certain distance, or may be reaching to the surface of the second side of the transparent cover plate as illustrated in FIG. 3. In either arrangement of the blind holes, all the first ends of several blind holes may be connected with first conducting plates, and all the second ends of several blind holes may be connected with second conducting plates, depending on the requirements of those skilled in the art, without particularly limited in the embodiments of the present invention.

In an example, as illustrated in FIG. 3, the display device may further include a transparent dielectric layer 14 disposed between the display panel 11 and the transparent cover plate 12. It should be understood that, the transparent dielectric layer 14 may have a single-layered structure or a multi-layered structure, and may be formed of one or more types of material. Furthermore, the transparent dielectric layer 14 may include color filter, polarizer or liquid optically clear adhesive (LOCA), depending on the display mode of the display panel 11, without particularly limited in the embodiments of the present invention. As it can be seen, the transparent dielectric layer 14, structurally, serves for buffering, supporting, and also decreasing the interference of signal to electric fields at both sides.

In an example as illustrated in FIG. 3, the fingerprint identification alarm circuit 13 is disposed on a flexible circuit board 15. The flexible circuit board 15 is disposed on a side of the full-screen fingerprint sensor 12a far away from the transparent cover plate 12 and is electrically connected with the full-screen fingerprint sensor 12a. The flexible circuit board 15 as illustrated in FIG. 15 represents a shape like “ [symbol] ”, serves for both of supporting the fingerprint identification alarm circuit 13 and establishing an electric connection between the fingerprint identification alarm circuit 13 and the full-screen fingerprint sensor 12a. As it can be seen, with such arrangement, the fingerprint identification alarm circuit may be configured independently from other circuits in the display panel, which improves the reliability.

It should be understood that, in some other embodiments, the fingerprint identification alarm circuit 13 may be disposed in a peripheral circuit region of the display panel and is connected with the full-screen fingerprint sensor through a lead.

FIG. 4 is a schematic structural view of a display device provided by yet another embodiment of the present invention. With reference to FIG. 4, in the display device, the fingerprint identification alarm circuit 13 is disposed in the peripheral circuit region of the display panel, along with a data driving circuit and a timing control circuit; and the electric connection between the fingerprint identification alarm circuit 13 and the full-screen fingerprint sensor 12a may be implemented by the flexible circuit board 15 containing leads. In the present embodiment, the fingerprint identification alarm circuit is integrated in the peripheral circuit of the display panel, which facilitates reducing a dimension of the final product.

In the structure of the display device provided by any of the foregoing embodiments, the fingerprint identification alarm circuit 13 may further include a memory unit (not illustrated) connected with the comparison unit. The memory unit stores a pre-stored fingerprint feature. In this way, storage elements of the memory unit may be disposed in the fingerprint identification alarm circuit to further simplify the structure and increase the response speed.

In the structure of the display device provided by any of the foregoing embodiments, the fingerprint identification alarm circuit 13 may further include an energy-storage power supply not illustrated in the drawings. As it can be seen, by using an independent power supply, a real-time monitoring of user identification may be achieved to further improve the safety. In some other embodiments, the fingerprint identification alarm circuit 13 may share the same energy-storage power supply with the display panel 11, which facilitates reducing the dimension of the final product.

Moreover, in the structure of the display device provided by any of the foregoing embodiments, the full-screen fingerprint sensor 12a may be further configured to acquire touch information on the surface of the second side of the transparent cover plate 12. For instance, a target touch position may be obtained from the fingerprint image as acquired by using image processing technology so as to obtain the above-mentioned touch information. As it can be seen, in the display device provided by the embodiment of the present invention, the touch function and the fingerprint-based alarm function are integrated in a single structure, which provides support for more powerful product functions.

In addition, it should be explained that, the transparent cover plate 12 disposed on the display panel 11 in the display device provided by the foregoing embodiments is illustrated as a flat plate, although the embodiments of the present invention are not limited thereto. For example, the transparent cover plate may be formed as any of a curved plate, a cylinder and a sphere, etc.

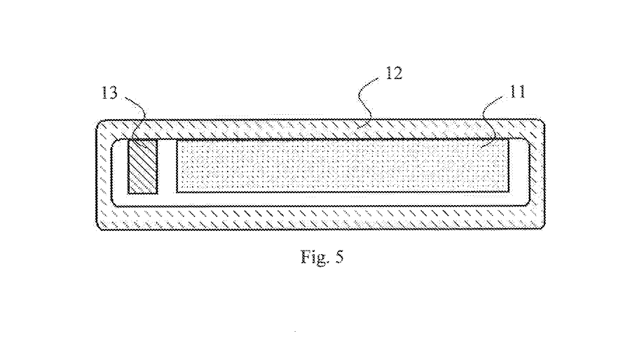

FIG. 5 is a schematic view illustrating an entire structure of a display device provided by still another embodiment of the present invention. With reference to FIG. 5, the display device includes a display panel 11, a transparent cover plate 12 disposed on the display panel 11, and a fingerprint identification alarm circuit 13 disposed on a first side of the transparent cover plate 12. In the present embodiment, the transparent cover plate 12 encloses the display panel 11 in a cavity formed by the surface of the first side of the transparent cover plate 12; furthermore, the surface of the second side of the transparent cover plate 12 opposite to the first side is formed as an outer surface of the entire display device. As it can be seen, in the present embodiment, the first side of the transparent cover plate 12 refers to an inner side of the transparent cover plate 12, while the second side of the transparent cover plate 12 refers to an outer side of the transparent cover plate 12. In this way, the display device provided by the embodiment of the present invention allows a fingerprint acquisition area to cover the entire surface of the display device, so as to achieve even more comprehensive alarm function and further improve the safety of usage.

Obviously, various modifications and deformations can be made to the present invention by those skilled in the art without departing from the spirit and scope of the present invention. Therefore, the present invention is intended to include the modifications and deformations fallen within the scope of the appended claims and equivalents thereof.

The present application claims the benefits of Chinese patent application No. 201510648557.0 filed with the SIPO on Oct. 9, 2015 under the title “DISPLAY DEVICE”, which is incorporated herein by reference as part of the application.

1. A display device, comprising:
a display panel; and
a transparent cover plate disposed on the display panel, wherein a first side of the transparent cover plate close to the display panel is provided with a full-screen fingerprint sensor and a fingerprint identification alarm circuit, wherein the full-screen fingerprint sensor is configured to acquire fingerprint information at a surface of a second side of the transparent cover plate opposite to the first side; and
the fingerprint identification alarm circuit comprises:
a receiving unit connected to the full-screen fingerprint sensor and configured to receive the fingerprint information from the full-screen fingerprint sensor;
an extracting unit connected to the receiving unit and configured to extract a fingerprint feature from the fingerprint information received by the receiving unit;
a comparison unit connected to the extracting unit and configured to compare the fingerprint feature extracted by the extracting unit with a pre-stored fingerprint feature; and
an alarming unit connected to the comparison unit and configured to perform an alarming operation upon the fingerprint feature being inconsistent with the pre-stored fingerprint feature.

2. The display device of claim 1, wherein the transparent cover plate is formed with a plurality of blind holes extending along a thickness direction of the transparent cover plate;
a depth of the blind hole is smaller than a thickness of the transparent cover plate; and
the blind hole is filled with a dielectric anisotropy material.

3. The display device of claim 2, wherein the dielectric anisotropy material has an optical property similar to that of the transparent cover plate.

4. The display device of claim 2, wherein the blind hole has a first end reaching to the surface of the first side of the transparent cover plate; and
the first end of the blind hole is connected with a first conducting plate.

5. The display device of claim 2, wherein the blind hole has a second end reaching to a surface of the second side of the transparent cover plate; and
the second end of the blind hole is connected with a second conducting plate.

6. The display device of claim 1, wherein the full-screen fingerprint sensor is attached onto the surface of the first side of the transparent cover plate by a bonding layer.

7. The display device of claim 1, further comprising a transparent dielectric layer disposed between the display panel and the transparent cover plate.

8. The display device of claim 7, wherein the transparent dielectric layer is selected from a group consisted of color filter, polarizer and liquid optically clear adhesive (LOCA).

9. The display device of claim 1, wherein the fingerprint identification alarm circuit is disposed on a flexible circuit board;
the flexible circuit board is disposed on a side of the full-screen fingerprint sensor far away from the transparent cover plate and is electrically connected with the full-screen fingerprint sensor.

10. The display device of claim 1, wherein the fingerprint identification alarm circuit is disposed in a peripheral circuit region of the display panel and is connected with the full-screen fingerprint sensor through a lead.

11. The display device of claim 1, wherein the fingerprint identification alarm circuit further comprises a memory unit connected with the comparison unit, the memory unit is configured to store the pre-stored fingerprint feature.

12. The display device of claim 1, wherein the fingerprint identification alarm circuit further comprises an energy-storage power supply.

13. The display device of claim 1, wherein the full-screen fingerprint sensor is further configured to acquire touch information on a surface of the second side of the transparent cover plate.

14. The display device of claim 1, wherein the transparent cover plate is selected from a group consisted of flat plate, curved plate, cylinder and sphere.

15. The display device of claim 1, wherein the transparent cover plate is configured to enclose the display panel in a cavity formed by the surface of the first side of the transparent cover plate; and a surface of the second side of the transparent cover plate is formed as an outer surface of the display device.

16. The display device of claim 4, wherein the blind hole has a second end reaching to a surface of the second side of the transparent cover plate; and
the second end of the blind hole is connected with a second conducting plate.

17. The display device of claim 2, wherein the full-screen fingerprint sensor is further configured to acquire touch information on a surface of the second side of the transparent cover plate.

18. The display device of claim 2, wherein the transparent cover plate is selected from a group consisted of flat plate, curved plate, cylinder and sphere.

19. The display device of claim 2, wherein the transparent cover plate is configured to enclose the display panel in a cavity formed by the surface of the first side of the transparent cover plate; and a surface of the second side of the transparent cover plate is formed as an outer surface of the display device.
